(19) United States
(12) Patent Application Publication
(10) Pub. No.: US 2015/0290620 A1
(43) Pub. Date: Oct. 15, 2015

(54) CATALYST COMPRISING IRON AND CARBON NANOTUBES

(71) Applicant: UNIVERSITY OF BATH, Bath, Avon (GB)

(72) Inventors: Matthew David Jones, Bradley Stoke (GB); Davide Mattia, Bristol (GB); Justin Patrick O'Byrne, Bath (GB); Rhodri Ellis Owen, Cardigan (GB); Daniel Minett, Prestwich (GB); Pawel Plucinski, Bath (GB); Sofia Ioana Pascu, Oxford (GB)

(73) Assignee: University of Bath, Bath, Avon (GB)

(21) Appl. No.: 14/443,245

(22) PCT Filed: Nov. 15, 2013
(86) PCT No.: PCT/GB2013/053014

§ 371 Date: May 15, 2015

(30) Foreign Application Priority Data
Nov. 16, 2012 (GB) 1220691.8

(51) Int. Cl. B01J 21/18; B01J 35/00; C10G 2/00; B01J 37/14; B01J 37/18; B01J 37/02; B01J 23/745; B01J 35/04

(52) U.S. Cl. CPC B01J 21/185; B01J 23/745; B01J 35/0006; B01J 35/04; B01J 35/0073; B01J 37/14; B01J 37/18; B01J 37/0238; C10G 2/50; C10G 2/332

(57) ABSTRACT

Improved catalyst comprising iron and carbon nanotubes. The invention relates to a process for making a catalyst comprising carbon nanotubes and iron-based particles, the process comprising the steps of: a)preparing carbon nanotubes comprising iron-based particles by chemical vapour deposition of a vapour of a carbon-containing substance in the presence of an iron-containing substance; b) subjecting the carbon nanotubes comprising iron-based particles to oxidising conditions to selectively etch away graphite layers covering the iron-based particles, thereby exposing the iron-based particles at the surface of the carbon nanotubes and at least partially oxidising the iron-based particles; and c) subjecting the carbon nanotubes comprising iron-based particles to reducing conditions in order to at least partially reduce the iron-based particles. The catalyst may be used in the manufacture of hydrocarbons from carbon monoxide or carbon dioxide, or for carbon capture and utilization.

### FIELD OF THE INVENTION

The invention relates to a process for making a catalyst comprising carbon nanotubes and iron-based particles, to a catalyst comprising carbon nanotubes and iron-based particles and to a process for the manufacture of hydrocarbons using the catalyst.

### BACKGROUND

In the context of the debate about global warming and its effects, carbon capture and storage (CCS) is currently being promoted as one of the most promising solutions to prevent further CO₂ emission from power plants and industries. Simply storing CO₂, though, locks away a potentially large-scale feedstock for the chemical industry, one that is alternative to fossil fuels and, for now, without cost. This advantage is one reason behind the development of the Fischer-Tropsch (FT) process for the conversion of CO and hydrogen into liquid hydrocarbons known since the 1920s, using iron or cobalt catalysts. Recent publications have shown that the efficiency of converting CO to hydrocarbons can be increased significantly and be commercially competitive at current oil prices. High oil prices combined with the significant costs associated with retrofitting existing plants to capture carbon emissions open the opportunity for CO₂ to become a commercially viable feedstock for hydrocarbon production.

Carbon nanomaterials have been used as catalyst supports for heterogeneous catalysis, showing good adhesion for metal particles, stability at elevated temperatures, and relative chemical inertness. Torres Galvis et al, Science, 2012, 335, 835-838 disclose the use of catalysts comprising iron supported on α-alumina or on carbon nanofibres in the Fischer-Tropsch reaction of carbon monoxide.

Despite this recent work there remains a need for improved catalysts which are capable of producing hydrocarbons from carbon dioxide.

### SUMMARY OF THE INVENTION

The invention provides in one aspect a process for making a catalyst comprising carbon nanotubes and iron-based particles, the process comprising the steps of:
a) preparing carbon nanotubes comprising iron-based particles by chemical vapour deposition of a vapour of a carbon-containing substance in the presence of an iron-containing substance;
b) subjecting the carbon nanotubes comprising iron-based particles to oxidising conditions to selectively etch away graphite layers covering the iron-based particles, thereby exposing the iron-based particles at the surface of the carbon nanotubes and at least partially oxidising the iron-based particles; and
c) subjecting the carbon nanotubes comprising iron-based particles to reducing conditions in order to at least partially reduce the iron-based particles.

Optionally, steps a) and b) can be carried out in one location and step c) in a second location. For example, it may be desirable to carry out steps a) and b) in one location to make a composition which is then transported to a second location where it is put in place in a reactor where it is to be used and reduced in situ by carrying out step c) in that reactor. That avoids the possibility that the iron re-oxidises during transport from the place it is manufactured to the place it is used. Accordingly, the invention provides in a further aspect, a process for making a composition comprising carbon nanotubes and iron-based particles, the process comprising the steps of: a) preparing carbon nanotubes comprising iron-based particles by chemical vapour deposition of a vapour of a carbon-containing substance in the presence of an iron-containing substance; b) subjecting the carbon nanotubes comprising iron-based particles to oxidising conditions to selectively etch away graphite layers covering the iron-based particles, thereby exposing the iron-based particles at the surface of the carbon nanotubes and at least partially oxidising the iron-based particles, thereby forming the composition. The invention also provides a composition obtainable by that process and a process for making a catalyst by subjecting that composition to in situ reduction.

Previous attempts to prepare catalysts comprising iron particles supported on carbon nanotubes have typically involved preparing the carbon nanotubes and in a subsequent step mixing the carbon nanotubes with a suspension of fine iron particles, then evaporating off the diluent to leave the iron particles supported on the surfaces of the carbon nanotubes. Any iron present during the initial synthesis of the carbon nanotubes has generally been removed from the carbon nanotubes by treatment with acid to leave pristine nanotubes before the subsequent stage of supporting the iron particles. In contrast, the present inventors have found that by preparing the carbon nanotubes by a chemical vapour deposition technique, preferably an aerosol-based chemical vapour deposition method, using a vapour of a carbon-containing substance in the presence of an iron-containing substance, carbon nanotubes comprising iron-based particles are produced. Those iron-based particles are generally coated by layers of carbon which render them largely ineffective for catalysis. The present inventors have however also found that it is possible to selectively oxidise the layers of graphite coating the iron-based particles. That selective oxidation is thought to be possible because those layers of graphite will generally have a higher degree of curvature than the walls of the carbon nanotube and hence be more strained, and more susceptible to oxidation. Following the selective oxidation the iron-based particles can be at least partially reduced to provide active catalysts having an enhanced catalytic activity.

Metal particles deposited on carbon nanotubes exhibit different behaviours over flat non-nanotube carbon supports due to the well graphitised and more strained nature of the curved support.

In the present invention, a process of forming a catalyst having iron-based particles on the surface of carbon nanoparticles, preferably, multi-walled carbon nanotubes, has been developed. The iron nanoparticles formed when catalysing carbon nanotube growth also form discrete particles on the surface of the carbon nanotubes. The present inventors have found that those particles are more active than iron particles of similar size which are deposited on the surface of purified nanotubes after the nanotubes have formed. Although not wishing to be bound by theory, one possible explanation for this activity difference is an increased interaction between the iron-based particles and the surface of the nanotubes in the catalysts in the invention as compared to the iron deposited on carbon nanotubes ex-situ in a subsequent step. The increased interaction is believed to enhance the spill-over of hydrogen from the iron-based particles onto the carbon surface, leading to a more potent catalyst. In particular, this allows the production of more active and efficient catalysts for CO₂ and CO reduction to hydrocarbons, although the catalysts of the invention may also be useful in other types of catalytic reaction, especially reduction reactions.

In a further aspect the invention provides a catalyst comprising carbon nanotubes and iron-based particles located on the surfaces of the carbon nanotubes, at least some, preferably at least 50%, of the iron-based particles each having a surface which is in contact with the surface of a carbon nanotube to form a contact region having a diameter of at least 10 nm. Preferably, the catalyst is produced by the process of the invention.

In a further aspect, the invention provides a catalyst comprising carbon nanotubes and iron-based particles located on the surfaces of the carbon nanotubes, in which at least some, preferably at least 50% of the iron-based particles are each in contact with a carbon nanotube to form a contact region, the contact region having an area which is from 1 to 50%, preferably from 10 to 40%, of the total surface area of the iron-based particle.

In a yet further aspect the invention provides a process for the manufacture of hydrocarbons comprising the step of reacting carbon monoxide, carbon dioxide, or a mixture of both, with hydrogen in the presence of a catalyst obtainable by the process of the invention or with a catalyst according to the invention.

### DETAILED DESCRIPTION OF THE INVENTION

Carbon nanotubes and methods for the preparation of carbon nanotubes are well known. The carbon nanotubes for use in the invention may be of any form suitable for use as a support for catalytic particles. Preferably, the carbon nanotubes are multiwalled carbon nanotubes.

The term ‘iron-based particles’ as used herein refers to particles comprising iron in a form capable of acting as a catalyst. The iron-based particles typically comprise metallic iron, iron (II) oxide, iron (III) oxide, or a mixture thereof but it is within the scope of the invention for the iron-based particles to include other iron compounds. The iron-based particles are formed during the preparation of the carbon nanotubes and are therefore more intimately connected with the walls of the carbon nanotubes than particles which are deposited on carbon nanotubes in a treatment step subsequent to the formation of the carbon nanotubes. The iron based particles may, for example, comprise at least 50 wt %, preferably at least 70 wt %, more preferably at least 90 wt % of iron and iron oxide(s). Optionally, the iron based particles essentially consist of metallic iron, iron (II) oxide, iron (III) oxide or a mixture thereof.

It will be apparent that during the process of the invention the composition of the iron-based particles is likely to change from an initial state into a more oxidised state and then into a reduced state. The term “iron-based particles” as used herein should be taken to refer to the particles in any of those states, according to the context.

The preparation of carbon nanotubes by chemical vapour deposition is well known and the process of the invention may include any variations of that process which are suitable for preparing the catalyst of the invention. Preferably, step a) of the process of the invention involves preparing carbon nanotubes by aerosol-based chemical based vapour deposition. The carbon-containing substance may be any suitable carbon-containing substance. For example, the carbon-containing substance may be an aromatic compound such as toluene.

The inclusion of an iron-containing substance during chemical vapour deposition of carbon nanotubes is well known because such iron-containing substances are often used to promote the formation of the carbon nanotubes. Any iron-containing substance which is suitable for use in carbon nanotube preparation may be used. Preferably, the iron-containing substance is a volatile organic substance, for example, ferrocene.

The carbon nanotubes may be grown on a monolithic substrate, for example, an alumina, cordierite or quartz substrate. Preferably, the monolithic substrate is of a form suitable for use as a catalytic structure to catalyse the reduction of a gaseous compound. For example, the monolithic substrate may be of a form having many passages through which the gaseous compound is transported so it comes into contact with the carbon nanotubes of a catalyst supported on the substrate. For example, the monolithic substrate may be of a honeycomb configuration.

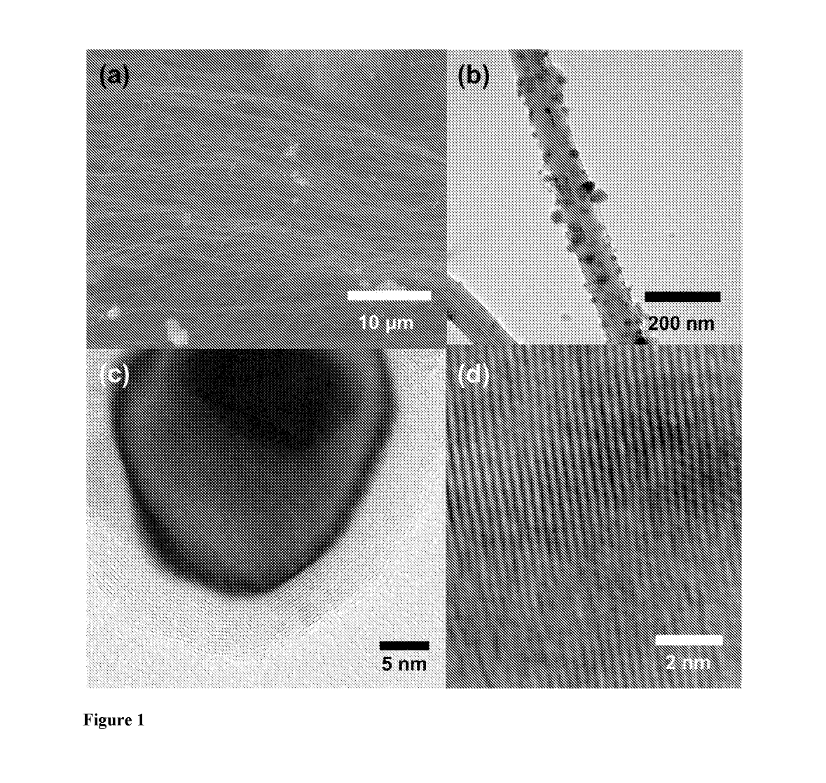

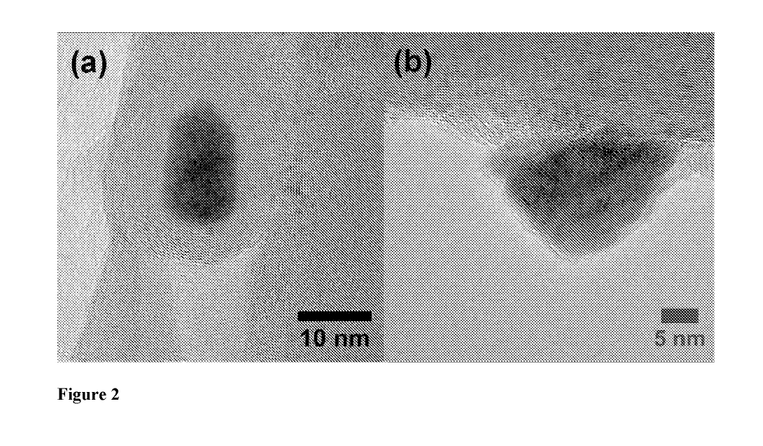

Examples of carbon nanotubes comprising iron based particles as prepared in step a) of the process of the invention is shown in FIGS. 1(a) to 1(d) and 2(a) and (b). As shown in those figures (see especially FIG. 1c and 2a) the iron-based particles on the surfaces of the carbon nanotubes are covered or masked by layers of graphitic carbon and the present inventors have found that such carbon nanotubes have a relatively low catalytic activity, presumably because the graphitic layers prevent access of the reactants to the iron-based particles.

In step b) of the process of the invention the carbon layers masking the iron-based particles are etched away by exposing the carbon nanotubes to oxidising conditions. Those oxidising conditions are selected to selectively oxidise the graphitic layers covering the iron-based particles, while not being so severe as to destroy the walls of the carbon nanotubes themselves. Such selective oxidation of the masking layers of carbon is believed to be possible because those layers have a higher degree of curvature than the walls of the nanotubes and therefore have a higher degree of strain and are more susceptible of oxidation.

Any suitable technique for such selective oxidation of masking layers may be used. For example, the oxidising conditions may include exposure of the carbon nanotubes comprising iron-based particles to an oxidising atmosphere such as air, steam, carbon dioxide or oxygen. Preferably, air is used for reasons of cost and convenience. Step b) preferably involves heating the carbon nanotubes to a temperature in the range of from 100° C. to 620° C., preferably from 300° C. to 620° C., more preferably from 520° C. to 620° C., more preferably from 550° C. to 600° C. The duration of the oxidation may be in the range of from 1 minute to 24 hours, preferably in the range of from 10 minutes to 2 hours, more preferably in the range of from 20 minutes to 1 hour. Overall the oxidising conditions should be chosen so that they are severe enough to etch away the graphitic layers of carbon covering the iron-based particles but, are not so severe that they significantly damage the walls of the carbon nanotubes.

FIG. 2 shows micrographs of a carbon nanotube comprising an iron-based particle of the invention before (FIG. 2a) and after (FIG. 2b) the oxidation step. As can be seen in FIG. 2, the graphitic layers masking the iron-based particle have been substantially removed, thereby exposing the iron-based particles.

In step c) of the process of the invention the carbon nanotubes comprising iron-based particles are exposed to reducing conditions in order to at least partially reduce the iron-based particles. The reducing conditions preferably involve exposure of the carbon nanotubes comprising iron-based particles to a reducing atmosphere, for example, a hydrogen atmosphere. Optionally the carbon nanotubes comprising iron-based particles are exposed to a reducing atmosphere, for example, a hydrogen atmosphere, and are heated to a temperature in the range from 350° C. to 500° C., preferably in the range of from 370° C. to 450° C. The duration of the reducing treatment is preferably in the range from 30 minutes to 24 hours, more preferably from 1 hour to 5 hours, more preferably from 2 hours to 4 hours.

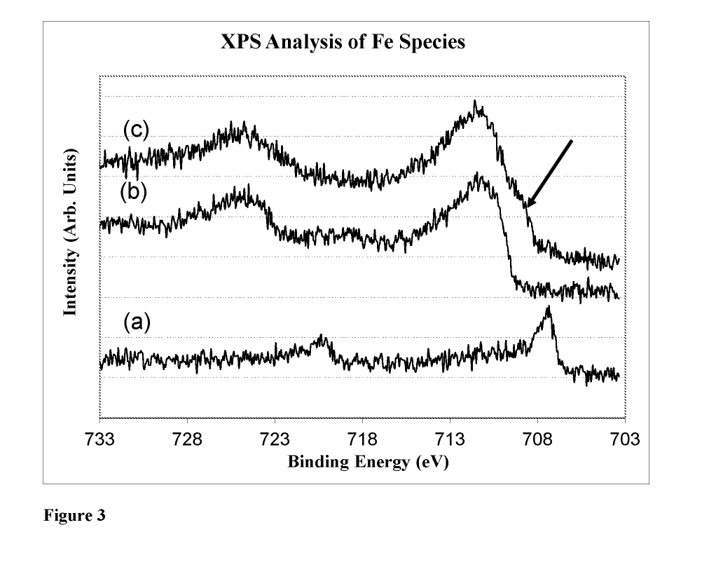

Following the reducing treatment of step c) of the process of the invention, the iron-based particles may comprise, for example, a mixture of iron (II) oxide and iron (III) oxide. FIG. 3 shows an X-ray photoelectron spectroscopy (XPS) analysis of the oxidation states of iron particles on the catalyst of the invention after step a), after step b) and after step c). After step a) a weak iron signal is recorded, presumably due to the masking effect of the graphitic carbon. After the masking layers have been etched away in the oxidation step b) a peak associated with the presence of iron (III) is present, and after the reduction of step c), a shoulder is present indicating the presence of some iron (II).

Optionally, the iron-based particles are less than 200 nm in size, preferably less than 150 nm in size, optionally less than 100 nm in size as determined by electron microscopy. Optionally, the iron-based particles have a size greater than 1 nm, preferably greater than 5 nm, more preferably greater than 20 nm. Optionally, the iron-based particles have a size in the range of from 20 nm to 80 nm. The word ‘size’ as used in relation to the iron-based particles should be taken to mean the average particle size as determined by any suitable technique for example, electron microscopy. Advantageously, the average value of the longest dimension of the iron-based particles as viewed using transmission electron microscopy is in the range of from 1 nm to 200 nm, preferably in the range of 5 nm to 100 nm, more preferably in the range of 20 nm to 80 nm.

The loading of the iron-based particles on the carbon nanotubes can be varied according to the desired activity of the catalyst. Optionally, the carbon nanotubes comprising iron-based particles have an iron loading as determined by SEM combined with EDX of between 0.1 and 5 atom %, preferably between 0.5 and 2 atom %.

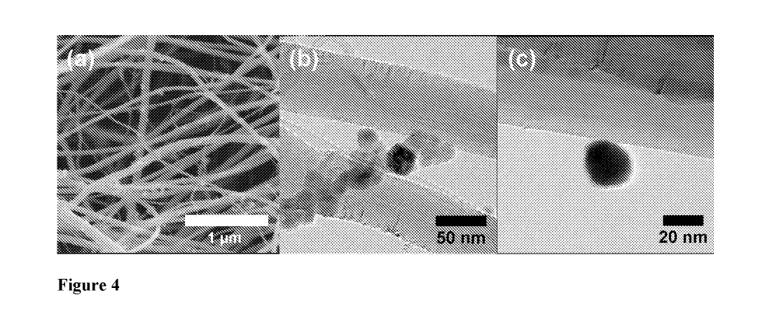

As can be seen from FIG. 2b, at least some of the iron-based particles have a pyramidal or conical shape. Advantageously, the cross-sectional area of the iron-based particles decreases in a radial direction away from the axis of the carbon nanotube to which the iron-based particles are attached. Optionally, at least some, for example, at least 50%, of the iron-based particles taper to a point in a direction away from the surface of the nanotube. In that way, the area of the iron-based particle which is in contact with the carbon nanotube is relatively broad and has a relatively large perimeter which is believed to promote the transfer of hydrogen from the iron-based particle to the carbon nanotube surface, thereby enhancing catalytic activity. Advantageously, the iron-based particles have bases which conform to the surface of the carbon nanotubes. Advantageously, the surfaces of at least some, preferably at least 50% of the iron-based particles, which are in contact with the carbon nanotube are substantially flat. This is in contrast to iron particles which have been deposited on a preformed carbon nanotube according to known processes, in which the iron particle is usually of a rounded shape and makes contact with the carbon nanotube through only a small portion of its surface. FIGS. 4a) to c) show a sample of carbon nanotubes which have been combined with iron particles according to a known process. As can be seen especially in FIG. 4c), the iron particles are rounded, and the area of contact between the particle and the nanotube is small.

Preferably, at least some of the iron-based particles, optionally more than 50% of the iron-based particles, each contact the carbon nanotube to which they are attached at a contact region having a diameter of at least 10 nm. As can be seen in FIG. 2b), the particle is approximately of an inverted triangular shape in cross section and one face of the iron-based particle makes contact with the curved surface of the carbon nanotube to form a contact region which in FIG. 2b) is approximately 25 nm in diameter. Preferably, at least some of the iron-based particles, optionally at least 50% of the iron-based particles, contact the carbon nanotube at a contact region having a diameter of at least 20 nm, preferably at least 25 nm. The word “diameter” as used herein in connection with the contact region between a carbon nanotube and an iron-based particle should be understood as referring to the width of the contact region at its widest point, and should not be taken to imply that the contact region is circular.

Optionally, at least some of the iron-based particles, optionally at least 50% of the iron-based particles, each contact the carbon nanotube to which they are attached at a contact region having an area which is from 1% to 50%, preferably from 10% to 40%, of the total surface area of the iron-based particle. The % of the surface area of the iron-based particle which is in contact with the carbon-nanotube can be calculated by measuring the relative dimensions of the iron-based particle and the contact region using transmission electron microscopy (TEM).

The comments above relating to the shape of the iron-based particles and to the interface between the iron-based particle and the carbon nanotube refer to the catalyst of the invention and to the catalyst made according to the process of the invention following step c).

The catalysts of the invention and the catalysts obtainable by the process of the invention are useful in various conversion reactions, for example, reduction reactions, especially the Fischer-Tropsch reduction of carbon monoxide or carbon dioxide to hydrocarbons. Accordingly, the invention provides a process for the manufacture of hydrocarbons comprising contacting carbon monoxide, carbon dioxide or a mixture of both with hydrogen in the presence of catalyst obtainable by the process of the invention or according to the invention. The contact takes place under conditions of temperature and pressure at which the carbon monoxide and/or carbon dioxide are reduced to form hydrocarbons. Optionally, the process is a Fischer-Tropsch reduction process. In one embodiment, the process involves combining carbon monoxide with hydrogen in the presence of the catalyst. In another embodiment, the process involves combining carbon dioxide with hydrogen in the presence of the catalyst. Preferably, the reduction of carbon dioxide to hydrocarbons occurs in a single step and in a single reactor.

Optionally, the carbon dioxide feedstock is obtained by capturing the carbon dioxide from the flue gas of a power plant or boiler. Advantageously, the carbon dioxide has been obtained by the combustion of a fossil fuel, for example, oil, coal or natural gas.

Optionally, the contact between the carbon monoxide and/or carbon dioxide with hydrogen in the presence of a catalyst takes place at a temperature in the range of from 325° C. to 425° C., preferably in the range of from 350° C. to 400° C. Optionally, the contact between the carbon monoxide and/or carbon dioxide with hydrogen in the presence of a catalyst takes place at a pressure in the range from 1 to 50 bar, preferably in the range from 2 to 12 bar. Advantageously, the process involves regeneration of the catalyst. The catalyst regeneration may be carried out continuously or batch-wise.

In a further aspect the invention provides a process of carbon capture and utilization which comprises the step of a) combusting a fossil fuel to heat energy and a flue gas comprising carbon dioxide; b) separating at least some, preferably at least 50%, of the carbon dioxide from the flue gas; and c) contacting the separated carbon dioxide with hydrogen in the presence of a catalyst obtainable by the process of the invention or according to the invention to generate an effluent comprising hydrocarbons. Optionally, the process of carbon capture and storage also includes the step of treating the separated carbon dioxide to remove catalyst poisons such as sulphur dioxide before it is contacted with the catalyst. Optionally, the process involves separating hydrocarbons from the effluent. Optionally, the effluent also comprises unreacted carbon dioxide and/or carbon monoxide and that unreacted carbon dioxide and/or carbon monoxide is recycled.

Embodiments of the invention will now be explained further for the purposes of illustration only and with reference to the following figures, in which:

FIG. 1(a) is a SEM micrograph showing the as-grown carbon nanotubes of Example 1;

FIG. 1(b) is a TEM micrograph showing iron nanoparticles on the surface of the carbon nanotubes of Example 1;

FIG. 1(c) shows graphitic layers formed on the surface of the as-grown nanoparticles of Example 1;

FIG. 1(d) shows a HRTEM micrograph of an iron nanoparticle on the surface of a carbon nanotubes of Example 1 showing the atomic lattice;

FIG. 2(a) shows a TEM micrograph showing an unoxidised, graphitic-coated, iron-based particle;

FIG. 2(b) shows a TEM micrograph showing an iron-based particle on the carbon nanotube surface after thermal oxidation at 570° C. in air;

FIG. 3 shows an XPS analysis of the oxidation states of iron-based particles on the catalysts of Example 1 (a) as-grown i.e. before oxidation to remove graphitic layers covering the iron-based particles, (b) after oxidation for 40 min at 570° C., and (c) after being reduced in 50 sccm H2 for 3 280 min;

FIG. 4(a) shows a SEM micrograph of the catalyst of comparative Example 2;

FIG. 4(b) shows a TEM micrograph of the catalyst of comparative Example 2.

FIG. 4(c) shows a TEM micrograph of the catalyst of comparative Example 2.

### EXAMPLES

### Example 1

### Synthesis Procedure

Carbon nanotubes were generated by an aerosol-based chemical vapour deposition of ferrocene (0.2 g) dissolved in toluene (10 ml). The ferrocene/toluene solution was injected using a syringe pump at a rate of 10 ml/hr under 450 sccm Ar and 50 sccm H₂ into a quartz tube at 790° C. according to the method described by Singh, Schaffer and Windle, Carbon, 2003, 41(2), 359-368. The carbon nanotubes were grown on a quartz substrate.

To remove the graphitised layers from the iron-based particles, the sample was exposed to air at 570° C. for 40 minutes while still in line.

### Comparative Example 2

### Synthesis Procedure

A sample of the carbon nanotubes made according to the first paragraph of Example 1, above, were purified by being dispersed in 10 M HCl and sonicated for 1 hour followed by stirring for 24 hours to remove the iron-based particles. The resultant solution was then filtered and washed until the washings were pH neutral. The solid was then re-dispersed in 6 M HNO₃ followed by sonication for 1 hour and stirred for 24 hours to oxidise the surface of the nanotubes, and again the solution was washed until the filtrate was pH neutral. Finally, the solid was dispersed in toluene and was mixed with a suspension of iron nanoparticles (<50 nm particles Sigma-Aldrich). This mixture was sonicated for 30 minutes and left stirring for 48 hours. The resultant solution was then gently heated to remove the toluene under stirring. The resultant black slurry was heated to 270° C. to dry for 1 hour.

Analysis of Catalysts

TEM was carried out on a JEOL 1200 operated at 200 kV, HRTEM imaging was carried out on a JEOL 2100 (LaB₆ filament) instrument operated at 200 kV. Samples for TEM analysis were prepared in ethanol and deposited onto Cu or Ni grids. SEM was carried out on a JEOL 6480LV at 5-25 kV. Energy-dispersive X-ray spectroscopy (EDS) was carried out in-situ during SEM analysis. The concentration of iron on the surface was calculated using the average of 5 area scans using SEM/EDS and confirmed using X-ray photoelectron spectroscopy (XPS). XPS analysis was carried out on a Kratos AXIS 165 spectrometer with the following parameters: Sample Temperature: 20-30° C. X-Ray Gun: mono Al K 1486.58 eV; 150 W (10 mA, 15 kV), Pass Energy: 160 eV for survey spectra and 20 eV for narrow regions. Step: 1 eV (survey), 0.05 eV (regions), dwell: 50 ms (survey), 100 ms (regions), sweeps: survey ( 4), narrow regions (5-45). Calibration: the C is line at 284.8 eV was used as charge reference. Other: spectra were collected in the normal to the surface. Data processing: Construction and peak fitting of synthetic peaks in narrow region spectra used a Shirely-type background and the synthetic peaks were of a mixed Gaussian-Lorenzian type. Relative sensitivity factors used are from CasaXPS library containing Scofield cross-sections. Thermogravimetric Analysis (TGA) of carbon nanotubes was collected on a Mettler Toledo TGA/DSC 1 thermogravimetric analysed over a temperature range from 20 to 900° C. at a heating rate of 10° C. min⁻¹ under an air flow of ca. 25 ml min⁻¹. Samples were held at 900° C. for 40 min to ensure full burn-off of all carbons.

### Catalyst Structure—Example 1

The catalyst of Example 1 comprised iron-based particles ranging in size from 40-60 nm as seen from TEM analysis. Those iron-based particles were formed during the growth of carbon nanotubes using the aerosol-based chemical vapour deposition technique. FIGS. 1(a) and (b) show the formation of well graphitised carbon nanotubes with iron-based particles on their surface. As iron-based particles are formed on the surface of the tubes during growth, they exhibit a well-defined graphitic coating as shown in FIG. 1(c). FIG. 1(d) shows a HRTEM micrograph of a highly crystalline iron-based particle on the surface of a carbon nanotube encapsulated by graphitic layers.

Initially, the as-grown carbon nanotubes were tested for their catalytic properties. However, presumably due to the graphitic coating present on the iron-based particles' surface, there was negligible conversion. An in-line thermal oxidation treatment was undertaken which stripped the more physically strained carbon layers at the nanoparticles' surface but did not strip the less physically strained carbon layers in the nanotube. FIGS. 2(a) and (b) show iron-based particles on carbon nanotube walls with and without that carbon coating, before and after thermal treatment to remove the graphitic coating, respectively. FIG. 2(b) also shows that the carbon nanotube integrity is not compromised by the thermal oxidation, as confirmed by thermogravimetric analysis (TGA).

X-ray photoelectron spectroscopy was used to probe the iron content of the catalysts at the surface of the nanotubes. The as-grown samples (i.e. before the oxidation at 570° C. in air) of Example 1 showed metallic iron present at a concentration of 0.2 atom %. FIG. 3(a) shows an XPS spectra for the catalyst of Example 1. This low concentration is likely due to the attenuation of the signal due to the coating of the iron-based particles with graphitic layers (see FIG. 1(c) and FIG. 2(a)). XPS of a thermally oxidized sample showed a clear peak for Fe (III) (FIG. 3(b)). To emulate the reaction conditions and determine the active species, a sample of the carbon nanotubes after thermal oxidation was reduced under H₂ for 3 hours at 400° C. This reduced sample, analysed using XPS under air-free conditions, showed an iron concentration of ˜1.0 atom % and showed the presence of mixed iron oxide {Fe(II), Fe(III)} indicated by the presence of a shoulder at 709.5 eV in addition to the principal peaks at 711.5 and 719.5 eV (FIG. 3(c)).

### Catalyst Structure—Comparative Example 2

FIG. 4(a) shows HRSEM micrographs of the catalyst of Comparative Example 2. FIGS. 4(b) and (c) show the deposition of iron nanoparticles on the surface of the nanotubes. XPS analysis of the catalyst before reduction showed the iron to be Fe(III), and the loading to be 1 atom %. The XPS and SEM/EDS gave matching loadings of Fe on the surface of the carbon nanotubes.

Catalyst Testing

Each catalyst was loaded into a purpose built stainless steel packed-bed reactor (½″ (12.7 mm) diameter×12 cm length) that could be heated to a variety of temperatures and operated at a variety of pressures. The catalyst (masses of iron are given in Table 1) was reduced under a pure flow of H₂ 50 sccm at 400° C. for 3 hours under atmospheric pressure. For typical carbon dioxide-based experiments, CO₂ (2 sccm) and H₂ (6 sccm) were flowed over the catalysts (typically at 370° C.) at a pressure of 1 to 12 bar (typically 7.5 bar). In a typical CO based experiment, CO (2 sccm) and H₂ (4 sccm) were flowed over catalysts at 300-390° C. (typically at 370° C.) at a pressure of 1 to 12 bar (typically 7.5 bar).

The product gases were analysed using gas chromatography mass spectrometry (GCMS). Gas samples were taken from the exhaust gases of the reactor. Typically 30 ml of gas was sampled using a gas syringe and injected into an Agilent 7890A GCMS with a HP-PLOT/Q, 30 m long 0.530 mm diameter column. The GC-MS was calibrated with a BOC special gas with each gas composition 1% v/v CH₄, C₂H₆, C₃H₆, C₃H₈, C₄H₁₀, CO, CO₂, with N₂ makeup gas. The carbon mass balance was carried out by the following method: The total volume and composition of the injected gases was calculated per hour. The composition of the outlet gases was analysed using GC-MS and the molar composition was calculated from the peak area and response factors calculated from the calibration gases. In all cases the mass balance was found to be satisfactory and within the range of experimental error.

Table 1 shows the effective loadings of iron on each of the catalysts and the iron loading per run. The iron time yield (FTY) is reported in Tables 2 and 3 in order to normalise the conversion and activity of each catalyst, following the method reported by Torres Galvis et al, Science, 2012, 835-838. The FTY is defined as number of mols of CO or CO₂ reduced to products divided by grams of iron per second. XPS analysis coupled with SEM/EDS was used to calculate the iron loading on the surface of the supports. The amount of iron per catalyst is calculated to find the effective difference in catalyst loading in lieu of mass of catalyst used per test. The mass of catalyst used was varied to maintain the same volume of the packed bed, as the densities of the supports were significantly different (Table 1).

Table 2 shows the conversion of CO to hydrocarbons and the iron time yields from each of the catalysts of Example 1 and Comparative Example 2. The catalyst of Example 1 was a more effective catalyst than the catalyst of Comparative Example 2. The FTY_{CO} {iron time yield (mol CO converted to hydrocarbons/grams of iron used per second)} of both catalysts was found to be one order of magnitude greater (FTY_{CO} 1.41×10⁻⁶) at ambient pressure, with similar conversions at 20 bar as compared to the iron-carbon catalyst reported in the literature by Torres Galvis et al, Science, 2012, 835-838, albeit with slightly lower selectivity towards C₂+ hydrocarbons (˜57%).

Direct conversion of CO₂ using the catalyst of Example 1 yielded only 55% selectivity towards hydrocarbons, with the remainder being CO (Table 3). The catalyst of Comparative Example 2 was tested over a 65 hour period and the FTY_{CO2} decreased by approximately 20% in the first 12 hours but stabilised over the remainder of the 65 hour period. The catalyst of Example 1 gave better results than the catalyst of Comparative Example 2 for both selectivity to longer chain hydrocarbon formation from CO₂ and conversion, percentages as shown in Table 3. Both catalysts were tested at 1 bar.

TABLE 1
Catalyst loading in the reactor with the iron loading on the carbon
nanotube surface and the normalised iron content per reaction.
The variation in the masses of the catalyst loading is due to
the differences in the densities of each catalyst.

| | | Typical | |
|---|---|---|---|
| | Iron (%) loading | catalyst loading | Iron loading |
| Catalyst | on surface | (g) [a] | per run (g) |
| Example 1 | 1.1 | 0.4 | 0.004 |
| Com. Example 2 | 1.3 | 0.7 | 0.009 |

[a] Mass of catalyst needed to pack entire length of reactor

TABLE 2
Table of conversion of CO and selectivity. The iron time yield is reported
as the conversion of CO to hydrocarbons per grams of iron per second
(mol_{CO}/g_{Fe} s). The reactions are undertaken at
atmospheric pressure and at a temperature of 370° C.

| Catalyst | FTY (10⁻⁵) mol/g s | C1 | C2-4 | C5+ |
|---|---|---|---|---|
| Example 1 | 9.4 | 43.3 | 54.4 | 2.3 |
| Com. Example 2 | 6.0 | 41.6 | 53.6 | 4.5 |

TABLE 3
Table of conversion of CO₂ and selectivity. The FTY is reported as
conversion of CO₂ per grams of iron per second (mol_{CO2}/g_{Fe} s).
The reactions are undertaken at atmospheric pressure and at a
temperature of 370° C.

| Catalyst | FTY (10⁻⁵) mol/g s | CO | C1 | C2-4 | C5+ |
|---|---|---|---|---|---|
| Example 1 | 11 | 45.1 | 29.3 | 24.3 | 1.3 |
| Com. Example 2 | 3.0 | 82.4 | 12.4 | 5.2 | 0 |

1. A process for making a catalyst comprising carbon nanotubes and iron-based particles, the process comprising the steps of:
a) preparing carbon nanotubes comprising iron-based particles by chemical vapour deposition of a vapour of a carbon-containing substance in the presence of an iron-containing substance;
b) subjecting the carbon nanotubes comprising iron-based particles to oxidising conditions to selectively etch away graphite layers covering the iron-based particles, thereby exposing the iron-based particles at the surface of the carbon nanotubes and at least partially oxidising the iron-based particles; and
c) subjecting the carbon nanotubes comprising iron-based particles to reducing conditions in order to at least partially reduce the iron-based particles.

2. A process as claimed in claim 1 in which step b) includes heating the carbon nanotubes comprising iron-based particles in air to a temperature in the range of from 520° C. to 620° C.

3. A process as claimed in claim 1 in which step c) includes heating the carbon nanotubes comprising iron-based particles in a hydrogen atmosphere to a temperature in the range of from 350° C. to 500° C.

4. A process as claimed in claim 1 in which the iron-based particles have a size in the range of from 5 to 80 nm.

5. A process as claimed in claim 1 in which after step c) the carbon nanotubes comprising iron-based particles have an iron loading as determined by SEM combined with EDX of between 0.1 and 5 atom %.

6. A process as claimed in claim 1 in which after step c) the iron-based particles comprise a mixture of iron (II) oxide and iron (III) oxide, as determined by XPS.

7. A process as claimed in claim 1 in which after step b) the iron-based particles have bases which conform to the surfaces of the carbon nanotubes.

8. A process as claimed in claim 1 in which after step b) at least some of the iron-based particles contact the carbon nanotube at an interface having a diameter of at least 10 nm.

9. A process as claimed in claim 1, in which the cross-sectional area of the iron-based particles decreases in a radial direction away from the axis of the carbon nanotube to which the iron-based particles are attached.

10. A process as claimed in claim 1 in which the catalyst is formed on a monolithic support.

11. A process for making a composition comprising carbon nanotubes and iron-based particles, the process comprising the steps of:
a) preparing carbon nanotubes comprising iron-based particles by chemical vapour deposition of a vapour of a carbon-containing substance in the presence of an iron-containing substance;
b) subjecting the carbon nanotubes comprising iron-based particles to oxidising conditions to selectively etch away graphite layers covering the iron-based particles, thereby exposing the iron-based particles at the surface of the carbon nanotubes and at least partially oxidising the iron-based particles, thereby forming the composition.

12. A composition comprising carbon nanotubes and iron-based particles obtainable by the process of claim 11.

13. A process for making a catalyst comprising carbon nanotubes and iron-based particles comprising subjecting a composition made by the process of claim 11 to reducing conditions in order to at least partially reduce the iron-based particles.

14. A catalyst comprising carbon nanotubes and iron-based particles located on the surfaces of the carbon nanotubes, at least some, preferably at least 50%, of the iron-based particles each having a surface which is in contact with the surface of a carbon nanotube to form a contact region having a diameter of at least 10 nm.

15. A catalyst as claimed in claim 14 in which the surfaces of the at least some iron-based particles, preferably at least 50% of the iron-based particles, which are in contact with the carbon nanotube are substantially flat.

16. A catalyst as claimed in claim 14 in which the at least some, preferably at least 50%, of the iron-based particles taper to a point in the direction away from the surface of the carbon nanotube.

17. A process for the manufacture of hydrocarbons comprising reacting carbon monoxide, carbon dioxide, or a mixture of both, with hydrogen in the presence of a catalyst obtainable by the process of claim 1.

18. A process as claimed in claim 17 which comprises reacting carbon dioxide and hydrogen in the presence of the catalyst in a single step to produce an effluent comprising hydrocarbons.

19. A process of carbon capture and utilization, comprising the steps of:
a) combusting a fossil fuel to provide heat and a flue gas comprising carbon dioxide;
b) separating at least some of the carbon dioxide from the flue gas; and
c) contacting the separated carbon dioxide with hydrogen in the presence of a catalyst obtainable by the process of claim 1 to generate an effluent comprising hydrocarbons.

20. A process for the manufacture of hydrocarbons comprising reacting carbon monoxide, carbon dioxide, or a mixture of both, with hydrogen in the presence of a catalyst as claimed in claim 14.

21. A process as claimed in claim 20 which comprises reacting carbon dioxide and hydrogen in the presence of the catalyst in a single step to produce an effluent comprising hydrocarbons.

22. A process of carbon capture and utilization, comprising the steps of:
a) combusting a fossil fuel to provide heat and a flue gas comprising carbon dioxide;
b) separating at least some of the carbon dioxide from the flue gas; and
c) contacting the separated carbon dioxide with hydrogen in the presence of a catalyst as claimed in claim 14 to generate an effluent comprising hydrocarbons.
